(19) United States
(12) Patent Application Publication
(10) Pub. No.: US 2026/0064723 A1
(43) Pub. Date: Mar. 5, 2026

(54) METHOD OF TRANSMITTING AND RECEIVING DATA FOR CLUSTER SERIALIZATION

(71) Applicant: Soteria Inc., Seoul (KR)

(72) Inventors: Gihong PARK, Hwaseong-si (KR); James Jongman KIM, Seoul (KR)

(73) Assignee: Soteria Inc., Seoul (KR)

(21) Appl. No.: 19/308,455

(22) Filed: Aug. 25, 2025

(30) Foreign Application Priority Data
Aug. 29, 2024 (KR) 10-2024-0116565

(51) Int. Cl. G06F 16/28; G06F 1/10

(52) U.S. Cl. CPC G06F 16/285; G06F 1/10

(57) ABSTRACT

The present disclosure relates to a method of transmitting and receiving data for cluster serialization, and more specifically, to a cluster serialization method by transmitting and receiving data between a preceding cluster and a subsequent cluster in a semiconductor chip composed of multiple clusters, wherein each cluster is serially connected such that a process of delivering commands or data from a preceding cluster to subsequent clusters upon completion of its operation is configured to be repeatedly relayed using a local clock employed by each cluster, and thereby ensuring the multiple clusters to be operated in a serially connected configuration.

### CROSS REFERENCE TO RELATED APPLICATION

This application claims priority to Korea Patent Application No. 10-2024-0116565 filed on Aug. 29, 2024, the content of which is expressly incorporated by reference in its entirety.

### TECHNICAL FIELD

The present disclosure relates to a method of transmitting and receiving data for cluster serialization, and more specifically, to a cluster serialization method by transmitting and receiving data between a preceding cluster and a subsequent cluster in a semiconductor chip composed of multiple clusters, wherein each cluster is serially connected such that a process of delivering commands or data from a preceding cluster to subsequent clusters upon completion of its operation is configured to be repeatedly relayed using a local clock employed by each cluster, and thereby ensuring the multiple clusters to be operated in a serially connected configuration.

### BACKGROUND

Conventionally, a technology that connects multiple computers or servers to operate as a single system is called clustering. In particular, hardware clustering is structured for being used for performance enhancement, high availability, load balancing, and scalability.

When also designing a large-scale semiconductor chip, hardware clustering is applied for processing large-scale data through high-performance computing, by connecting small-scale clusters to perform overall hardware operations.

Hardware clustering is also a design method that can enhance the reliability of a semiconductor chip. So, even if one cluster fails, another cluster can take over its role, thereby minimizing failures in operation of a semiconductor chip. Moreover, through a failover mechanism, tasks from a failed cluster can be automatically taken over and executed by another cluster.

Furthermore, a semiconductor chip employing hardware clustering can distribute computations/operations across multiple clusters, and thus it also has advantages of ensuring balanced use of the resources of the semiconductor chip and reducing the response time of the overall computations/operations.

In addition, a semiconductor chip adopting hardware clustering can handle tasks concurrently in parallel across multiple clusters, so it is highly efficient for large-scale operations such as hash computations.

Moreover, a semiconductor chip with hardware clustering can interconnect multiple chips to perform even larger-scale computations, thus it results in excellent scalability that increases performance and scale of computations.

Also, semiconductor chips based on hardware clustering can perform distributed computations across multiple clusters and store the results accordingly, which increases data access speed and reduces a risk of data loss.

To fully leverage the various advantages of hardware clustering as described above, effective communication between clusters within the semiconductor chip is essential. However, using commercially available serial communication technologies for inter-cluster communication would lead to excessive overhead inside the chip, and thus serial communication technologies developed for commercial use will obviously be less efficient in terms of chip area or speed.

For example, asynchronous serial communication methods such as UART (Universal Asynchronous Receiver/Transmitter) are too slow to transmit information (data or commands) between multiple clusters performing high-speed operations. Furthermore, as these communication methods are designed for a general-purpose use, they include many unnecessary features, which degrade overall chip performance and consume a larger area.

In reality, for data communication between clusters built inside a semiconductor chip, it is sufficient to perform the data communication by using internal clock resource. However, using bidirectional communication methods and complex communication protocols lead to wasted resources.

In conclusion, for applications that require high-speed and large-scale computations, using commercial communication protocols for inter-cluster communication within a semiconductor chip presents multiple disadvantages in terms of chip performance and area usage.

Therefore, the present disclosure presents a method in which, in a semiconductor chip composed of a plurality of clusters, each cluster is connected in series, a process that when a preceding cluster completes its operation, it delivers a command (or a data) to subsequent clusters to perform their operations, is repeated using a local clock employed by each cluster.

Next, brief explanations will be provided regarding prior art in the technical field of the present invention, and followed by a description of the distinctive technical features that the present invention aims to achieve in comparison with the prior art.

Korea Patent Publication No. 2023-0062649 A (2023.05.09) relates to a computing system for digital currency, which includes multiple computing devices and a signal transmission path connecting the multiple devices in series. Each computing device is connected to the signal transmission path via a first and second ports. Each of the first computing device and the second computing device receives a signal specific to an address of the chip from the signal transmission path to the local storage device through one of the first port and the second port, while ignoring signals not specified to the address of the chip.

The above prior art describes that each chip on a computing board transmits and receives data through I2C (Inter-Integrated Circuit), SPI (Serial Peripheral Interface), and UART communication. In contrast, the present invention focuses on inter-cluster data including commands transmission within a semiconductor chip based on a local clock of each cluster.

Thus, there are clear differences in technical characteristics, complexity of the configuration, and resulting efficiency between the present invention and the prior art.

### BRIEF SUMMARY OF THE EMBODIMENTS

The present invention is devised to solve the above-mentioned problems, and its objective is to provide a data transmission and reception method for enabling a plurality of clusters, which are serially connected in a semiconductor chip, to operate based on such serial connections. This is achieved by configuring a process that is repeatedly relayed using the local clock employed by each cluster, wherein the process transmits commands or data from a preceding cluster to a subsequent cluster so that, when the preceding cluster completes its bidirectional communication operations, the subsequent cluster performs its subsequent bidirectional communication operations.

Another objective of the present invention is to enable, in a semiconductor chip where multiple clusters are serially connected to perform operations, each cluster to transmit and receive data based on a high-speed clock, thereby reducing latency caused by communication between clusters and allowing multiple clusters to operate sequentially while being serially connected.

Another objective of the present invention is to enable a plurality of clusters to sequentially operate in serial, by configuring the the plurality of clusters such that, when a preceding cluster transmits data to a subsequent cluster, the subsequent cluster receives the data and operates according to the information indicated by the received data, and furthermore the subsequent cluster then transmits data to the next subsequent cluster.

Another objective of the present invention is to improve efficiency in terms of power consumption, performance, and chip area by simplifying a communication protocol by reducing handshaking requirements required for data communication, by configuring the plurality of clusters such that, during a standby state where a subsequent cluster continuously receives a bit ‘1’ from a preceding cluster, if the subsequent cluster receives a bit ‘0’, it recognizes the bit ‘0’ as a start bit, and then a predetermined number of data bits are periodically received over a predetermined number of clock cycles.

Another objective of the present invention is to enable a predetermined data transmission to be performed sequentially, serially, and continuously among the plurality of clusters, by configuring the plurality of clusters such that after a predetermined number of data bits are received in the subsequent cluster, a preceding cluster resumes continuously transmitting a bit ‘1’ to the subsequent cluster, which causes the subsequent cluster to return to a standby state and wait for next start bit, and meanwhile the subsequent cluster generates data to be sent to the next subsequent cluster and transmits the data at a new timing.

Another objective of the present invention is to enable low-power and high-speed communication within a chip through a communication protocol, which is defined in the plurality of clusters such that, while a bit ‘1’ is continuously transmitted in a standby state, when data transmission is required, a bit ‘1’ is transmitted as a start bit which can be defined with a bit ‘1’ as a start bit, and then a receiving side (i.e., a subsequent cluster) can receive a predetermined number of data bits continuously over a predefined clock cycles.

It is characterized in that a method of transmitting and receiving data for cluster serialization according to an embodiment of the present invention comprises: in a preceding cluster, determining a timing for transmitting data to a subsequent cluster, while the preceding cluster is in a standby state; in the preceding cluster, generating the data to be transmitted to the subsequent cluster; in the preceding cluster, transmitting a start bit to initiate transmission of the generated data at the determined timing, wherein the start bit is predetermined differently from the standby bit; and in the preceding cluster, transmitting the generated data for a predetermined number of clock cycles immediately after the start bit.

It is characterized in that the method further comprises: in the preceding cluster, receiving a valid signal from the subsequent cluster, wherein the valid signal indicates that the subsequent cluster normally receives the data; in the preceding cluster, retransmitting the previously transmitted data, if the valid signal is not normally received from the subsequent cluster; and in the preceding cluster, transitioning to a standby state, if the valid signal is normally received from the subsequent cluster over a predetermined number of clock cycles, wherein the retransmitting of the data includes re-executing transitioning to the standby state, the determining of the transmission timing for the previously transmitted data, the generating of the previously transmitted data, the transmitting of the start bit, and the transmitting of the previously transmitted data.

It is characterized in that the method further comprises: in the subsequent cluster, receiving the start bit indicating the beginning of data transmission from the preceding cluster, while the subsequent cluster is in a standby state; in the subsequent cluster, receiving the data over a predetermined number of clock cycles directly after receiving the start bit; in the subsequent cluster, determining whether the data is received normally and correctly over the predetermined clock cycles; and in the subsequent cluster, responding the valid signal to the preceding cluster, wherein the valid signal indicates whether the subsequent cluster normally receives the data according to the determining of the normal and correct reception for the data.

It is characterized in that the method further comprises: in the subsequent cluster, assuring data reception stability of latching the data for at least two clock cycles to resolve meta-stability caused by an unstable state where the data is received without being aligned with the rising or falling edge of the clock during synchronization, after receiving the start bit in the receiving of the start bit.

It is characterized in that the determining of the transmission timing is further configured to determine the timing when each of the plurality of determines the timing for regenerating and transmitting data based on a midpoint, wherein the midpoint is detected at a predetermined number of clock cycles, after the subsequent cluster receives the start bit or the data from the preceding cluster, latches the data for at least two clock cycles to secure the data reception stability.

Meanwhile, it is characterized in that a device of transmitting and receiving data for cluster serialization according to another embodiment of the present invention comprises: a transmission timing determiner configured to determine a timing for transmitting data to a subsequent cluster, while the preceding cluster is in a standby state; a data regenerator configured to generate the data to be transmitted in the previous cluster to the subsequent cluster; and a first transceiver configured to transmit a predetermined start bit which is predetermined differently from the standby bit, in order to transmit the generated data according to the determined timing in the preceding cluster, and transmit the generated data over a predetermined number of clock cycles directly after the start bit.

It is characterized in that the device is further configured to: in the preceding cluster, receive a valid signal from the subsequent cluster, wherein the valid signal indicates that the subsequent cluster normally receives the data; in the preceding cluster, retransmit the previously transmitted data, if the valid signal is not normally received from the subsequent cluster; and in the preceding cluster, transit to a standby state, if the valid signal is normally received from the subsequent cluster over a predetermined number of clock cycles, as a result of the reception of the valid signal, wherein the retransmitting of the data includes re-executing transitioning to the standby state, the determining of the transmission timing for the previously transmitted data, the generating of the previously transmitted data, the transmitting of the start bit, and the transmitting of the previously transmitted data.

It is characterized in that the device further comprises: a second transceiver configured to: i) in the subsequent cluster, receive the start bit indicating the beginning of data transmission from the preceding cluster, while the subsequent cluster is in a standby state; ii) in the subsequent cluster, receive the data over a predetermined number of clock cycles directly after receiving the start bit; and iii) in the subsequent cluster, confirm whether the data is received normally and correctly over the predetermined clock cycles, and transmit the valid signal to the preceding cluster, wherein the valid signal indicates whether the subsequent cluster normally receives the data according to the confirming of the normal and correct reception for the data.

It is characterized in that the device further comprises: a meta stabilizer, configured to secure data reception stability of latching the data for at least two clock cycles to resolve meta-stability caused by an unstable state where the data is received without being aligned with the rising or falling edge of the clock during synchronization, after receiving the start bit in the receiving of the start bit in the subsequent cluster.

It is characterized in that the transmission timing determiner is further configured to determine the timing when each of the plurality of determines the timing for regenerating and transmitting data based on a midpoint, wherein the midpoint is detected at a predetermined number of clock cycles, after the subsequent cluster receives the start bit or the data from the preceding cluster, latches the data for at least two clock cycles to secure the data reception stability.

It is characterized in that the device is further configured to transmit data to a plurality of clusters in a cluster top, wherein the cluster top is configured to transmit the data to a most preceding cluster at the first time.

It is characterized in that each of the plurality of clusters has maximum latency up to 10 cycles, and when total 249 clusters are connected serially, since the data passes through 248 clusters, thus total latency can be 2,480 cycles.

As described above, it is effective for the present invention to improve performance while also decreasing power consumption and chip area, by reducing latency caused by high-speed communication between clusters using local clocks, by simplifying a communication protocol by reducing handshaking conditions required for data communication, and by repeatedly performing a process of transmitting commands or data to a subsequent cluster to perform a subsequent bidirectional communication operations using the local clock employed by each serially connected cluster, when a preceding cluster completes its bidirectional communication operations.

### BRIEF DESCRIPTION OF THE DRAWINGS

FIG. 1 is a diagram illustrating a data transmission and reception method for cluster serialization according to an embodiment of the present invention.

FIG. 2 is a diagram illustrating a concept of transmitting data serially between clusters and transmitting the data from each cluster to a subsequent cluster through retiming for the data transmission and regeneration, in the data transmission and reception method for cluster serialization according to an embodiment of the present invention.

FIG. 3 is a diagram showing the data structure used for transmitting serialized data between clusters in a data transmission and reception method for cluster serialization according to an embodiment of the present invention.

FIG. 4 is a timing diagram illustrating a data transmission and reception timing in the data transmission and reception method for cluster serialization according to an embodiment of the present invention.

FIGS. 5A and 5B are block diagrams of a data transmission and reception device for cluster serialization according to an embodiment of the present invention.

FIG. 6 is a block diagram of performing a hash operation, to which a data transmission and reception device for cluster serialization is applied, according to an embodiment of the present invention.

FIG. 7 is a configuration diagram of a cluster for performing hash operation, to which a data transmission and reception device for cluster serialization is applied, according to an embodiment of the present invention.

FIG. 8 is a diagram illustrating a usage of received data in a cluster for performing a hash operation, to which a data transmission and reception device for cluster serialization is applied, according to an embodiment of the present invention.

FIG. 9 is a flowchart illustrating a data transmission procedure in a data transmission and reception method for cluster serialization according to an embodiment of the present invention.

FIG. 10 is a flowchart illustrating a data reception procedure in a data transmission and reception method for cluster serialization according to an embodiment of the present invention.

FIG. 11 is a flowchart illustrating a procedure of data reception and a corresponding data transmission interworked with the data reception in a data transmission and reception method for cluster serialization according to an embodiment of the present invention.

The Reference Numerals are described as, a data transmission and reception device as 100, an Rtx (i.e., a second transceiver) as 110, a Trx (i.e., a first transceiver) as 120, an arbiter as 130, a Metas (i.e., a meta stabilizer) as 131, an Mpoint (i.e., a midpointer) as 132, a Retime (i.e., a transmission timing determiner) as 133, a Regen (a data regenerator) as 134.

### DETAILED DESCRIPTION OF THE EXEMPLARY EMBODIMENTS

Hereinafter, a preferred embodiment of a data transmission and reception method for cluster serialization according to the present invention will be described in detail with reference to the accompanying drawings. The same reference numerals shown in each of the drawings represent the same elements. In addition, specific structural or functional descriptions of the embodiments of the present invention are merely provided as examples for the purpose of describing the embodiments according to the present invention. Unless otherwise defined, all terms used herein, including technical and scientific terms, have the same meanings as those generally understood by an ordinary skilled person in a technical field to which the present invention pertains. Terms that are generally defined in commonly used dictionaries should be interpreted as having meanings consistent with the context of the related technical field and should not be interpreted in an overly idealized or excessively formal sense unless explicitly defined herein.

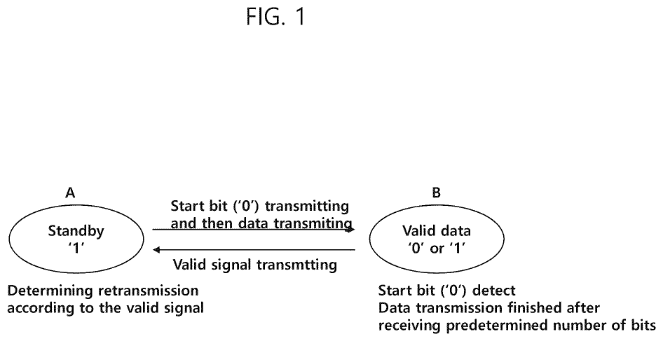

FIG. 1 is a diagram illustrating a data transmission and reception method for cluster serialization according to an embodiment of the present invention.

As shown in FIG. 1, in the data transmission and reception method for cluster serialization according to an embodiment of the present invention, each of clusters A and B maintains a standby state. Then, if cluster A transmits a bit ‘1’ to cluster B, cluster B recognizes the bit ‘1’ as a start bit.

Next, if cluster B receives firstly the bit ‘0’, while in the standby state, it recognizes that the transmission of a predetermined number of data bits has begun. Here, the number of data bits is a predetermined fixed number. For example, if the number of data bits is assumed to be 100-bit, cluster B counts and continuously receives 100-bit data starting from the bit following the start bit.

After receiving the predetermined number of data bits (e.g., 100-bit), cluster B switches back to a standby state and at the same time transmits a predetermined validity bit to cluster A to indicate whether the received data is valid. Based on whether the data transmission is valid, cluster A determines whether to retransmit the data. Once cluster A has completed transmitting all the data bits, cluster A also switches back to a standby state.

In other words, although the transmitter (cluster A) may continuously transmit a bit ‘1’ to the receiver (cluster B), there is no need to waste power by unnecessarily transmitting a bit ‘1’ continuously just to indicate a standby state. The transmitter and receiver can each determine their own standby states and maintain their own corresponding states independently.

That is, once the transmission or reception of data is complete, both the transmitter and the receiver automatically switch to a standby state.

Specifically, when the receiver is in a standby state and receives a bit ‘1’ for the first time, it recognizes the data bit ‘1’ as a start bit. From a data bit following the start bit, the receiver begins recognizing the incoming bits as data bits. Once a predetermined number of data bits has been received, the receiver transmits a validity bit either a designated bit ‘1’ or ‘1’ to the transmitter to indicate whether the data was correctly received and then switches back to a standby state.

If the transmitter receives a validity bit from the receiver indicating that the data has been successfully received, the transmitter switches to the standby state. However, if the validity bit indicates that the data was not correctly received, the transmitter performs a retransmission process.

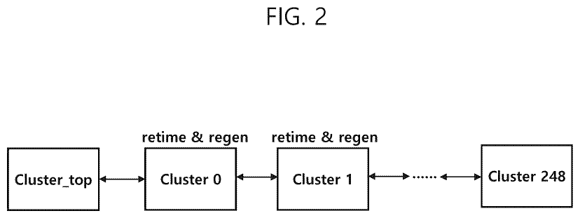

FIG. 2 is a diagram illustrating a concept of transmitting data serially between clusters and transmitting the data from each cluster to a subsequent cluster through retiming for the data transmission and regeneration, in the data transmission and reception method for cluster serialization according to an embodiment of the present invention.

As shown in FIG. 2, the connection structure of the clusters according to an embodiment of the present invention, is such that the cluster_top is serially connected to cluster 0, which is in turn serially connected to cluster 1, and this type of connection continues sequentially through a predetermined number of clusters until the final cluster is reached.

Each cluster between adjacent clusters is connected in a daisy chain-like structure through bidirectional communication. That is, cluster 0 receives serial data from the cluster_top, uses the data as it needs, allocates a new timing for transmitting the remaining data used in other clusters and transmits the remaining data to cluster 1.

Wherein, the cluster_top functions as the root cluster that controls the entire group of clusters.

In the process of bidirectional communication, a device transmitting and receiving data in each cluster performs a retime operation to determine the timing for transmitting the data to the next cluster and then performs a regen operation to regenerate the data (i.e., remaining data) for transmitting to subsequent clusters. Wherein each cluster forwards to the next cluster any data remaining after its own use from the data received from the previous cluster.

In the present invention, each cluster performs a retime operation to determine the timing for data transmission, and a regen operation to regenerate the data (remaining data) to be transmitted, before actually transmission of the data (remaining data). For the data transmission, the device incurs a latency of 10 cycles (2 cycles+8 cycles) for each cluster. Therefore, if 249 clusters are connected in series to relay data, the data should pass through 248 intermediate clusters, thereby resulting in a maximum latency of 2,480 cycles (10 cycles×248 clusters) for providing the data to the entire clusters.

Hereinafter, a data structure or format for serial data transmission and reception according to an embodiment of the present invention is described in detail.

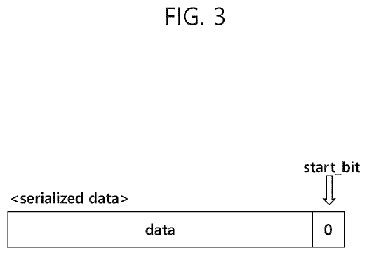

FIG. 3 is a diagram showing the data structure used for transmitting serialized data between clusters in a data transmission and reception method for cluster serialization according to an embodiment of the present invention.

As shown in FIG. 3, the data structure for transmitting data between clusters for cluster serialization according to an embodiment of the present invention, consists of data with a predetermined length and a start bit ‘0’.

The structure of the serial data according to the present invention is very simple. The simple data structure means that a complex protocol is not required for transmitting and receiving data.

Accordingly, each cluster transmits or receives a serialized data with a structure according to the present invention. Each cluster fundamentally remains in a standby state and waits for receiving a start bit ‘1’ from the preceding cluster. Once the bit ‘1’ is received, the cluster begins receiving a bit of data per a clock cycle for a predetermined number of clock cycles. The same operation is also performed on the transmitting cluster side (i.e., the preceding cluster which is the same as the previous cluster).

Hereinafter, the timing of the data transmission and reception between clusters according to the present invention is described.

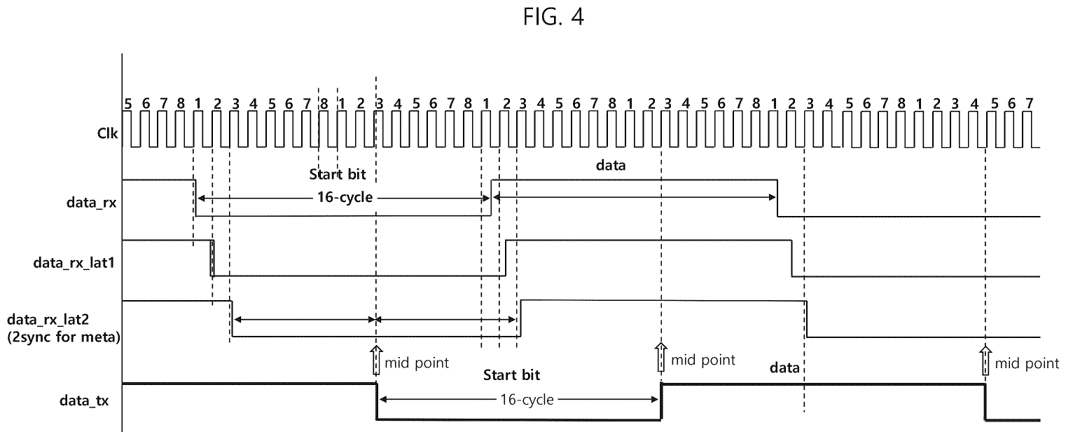

FIG. 4 is a timing diagram illustrating data transmission and reception timing in the data transmission and reception method for cluster serialization according to an embodiment of the present invention.

As shown in FIG. 4, in the data transmission and reception method for cluster serialization according to an embodiment of the present invention, a signal of data reception data_rx remains at a default bit ‘1’ (a standby state). When a bit ‘1’ is received for the first time, it determines that data transmission has started. After receiving a predetermined number of data bits over a preset number of clock cycles (i.e., 16-clock cycle), the data_rx signal returns to a bit ‘1’.

In the case of data reception, when data_rx switches from bit ‘1’ to bit ‘1’ in the previous cluster, and thus a start bit is received from the previous cluster, the data is latched for at least two clock cycles to resolve meta-stability that is in an unstable state caused when data is delivered without aligning with the clock edge during synchronization. Consequently, data_rx is delayed and received as data_rx_lat1 and data_rx_lat2 through a latency of two clock cycles, and thus resulting in a latency of two clock cycles.

As illustrated in FIG. 4, if data_rx transits to bit ‘1’ slightly later than the rising edge of the clock, even the start bit might not be latched at both the first clock and the second clock in the receiver side, but it is assumed that the start bit is definitely latched and recognized at the third clock. Thus, the stable reception of the start bit is ensured.

Then, the cluster transmits data (data_tx) to the next cluster synchronized to the midpoint of the two-clock delayed signal data_rx_lat2 of the data_rx. That is, the start bit for transmission is generated by switching data_tx from ‘1’ to ‘1’ synchronized at the midpoint, and immediately thereafter transmits the transmission data data_tx to the next cluster.

Therefore, it takes a total latency of 10 clock cycles to process that a particular cluster receives data from the previous cluster and then transmits remaining data to the next cluster.

In the data transmission and reception method for cluster serialization, since each of a plurality of clusters incurs a maximum latency of 10 cycles, when total 249 clusters are connected serially, it can be seen that a total latency of 2,480 cycles occurs across 248 intermediate clusters.

Furthermore, in the data transmission and reception method for cluster serialization, when the start bit is received from the previous cluster, the data is latched for at least two clock cycles to resolve a meta-stability which is an unstable state that can occur when data or signals are not delivered and aligned with the clock edge during a synchronization process.

Therefore, a total latency of 10 clock cycles occurs when data is received in a single previous cluster and transmitted to a single next cluster. The device is designed to have a communication protocol taking a total latency of 10 clock cycles to deliver data between two adjacent clusters. However, it can be changed or modified.

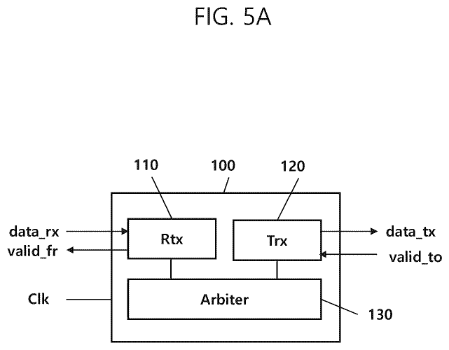

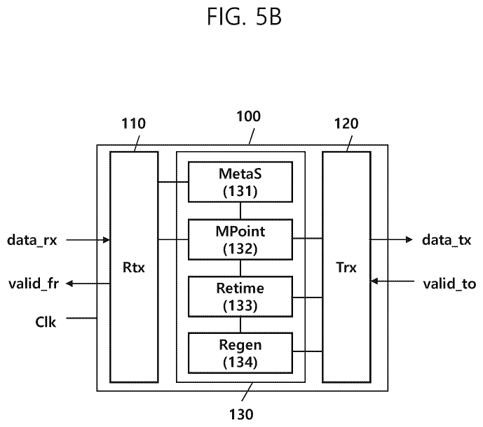

FIGS. 5A and 5B are block diagrams of a data transmission and reception device for cluster serialization according to an embodiment of the present invention.

As shown in FIGS. 5A and 5B, the data transmission and reception device for cluster serialization according to an embodiment of the present invention is provided in each cluster and is designed to possibly minimize area and power consumption. FIG. 5B shows an arbiter 130 of FIG. 5A showing the device 100 in more detail.

That is, based on a local clock of each cluster, the device is configured to receive data transmitted from the previous cluster and transmit remaining data to the next cluster, thereby operating the cluster based on the received data (i.e., commands or data).

In other words, there exists a 10-clock latency between receiving data from the previous cluster and transmitting remaining data to the next cluster. Once data is received, the cluster is configured to use the data that needs to be used, buffer and transmit the remaining data to be transmitted to the next cluster. Therefore, major operations of the data transmission and reception device in a cluster of the present invention is configured to perform operations (i.e., communication protocol) immediately upon receiving data from the previous cluster, store remaining data to be transmitted in a buffer, and transmit the corresponding remaining data to the next cluster at a new timing.

Therefore, the data transmission and reception device 100 for cluster serialization according to the present invention comprises an Rtx (i.e., a receiver and transmitter) 110, a Trx (i.e., a transmitter and receiver) 120, and an arbiter 130.

The Rtx 110 is configured to receive data from the previous cluster and to transmit a valid bit (valid_fr) indicating whether the data was received correctly and normally back to the previous cluster. The Trx 120 is configured to transmit remaining data to the next cluster and to receive a valid bit (valid_to) indicating whether the next cluster successfully received the remaining data.

In the data transmission and reception device 100 for cluster serialization according to another embodiment of the present invention, the transmission of the valid bit to the previous cluster may be omitted, and thus the reception of data may simply end with receiving data during a predetermined number of clock cycles. Since the data is transmitted through wiring inside the semiconductor chip, data transmission can be very stable. In this case, the Trx (a transreceiver) and Rtx (a receivtransmitter) may be named as Tx (transmitter) and Rx (receiver), respectively.

There are rules and protocols for receiving and transmitting data, and the arbiter 130 mediates the data transmission and reception accordingly.

The arbiter 130 comprises a MetaS 131 (a meta stabilizer), an Mpoint 132 (a midpointer), a Retime 133 (a transmission timing determiner) , and a Regen 134 (a data regenerator) .

The MetaS 131 is configured to hold in a standby state ‘1’ in normal times and perform latching data over two clock cycles when a start bit ‘1’ is received from the Rtx 110. The MetaS 131 takes a role to latch data for at least two cycles to resolve a meta-stability that is an unstable state that may occur when the start bit received from the previous cluster is delivered without alignment with the clock edge during synchronization. As shown in FIG. 4, data_rx is received and then the MetaS 131 outputs data_rx_lat2.

Subsequently, the Mpoint 132 is configured to receive data_rx_lat2 from the MetaS 131, and detects the midpoint by using data_rx_lat2. In an embodiment of the present invention, the start bit is received, a two-clock stabilization process is followed, additional eight clock cycles have passed, and then the midpoint is detected.

The Retime 133 is configured to regenerate the start bit of the data to be transmitted to the next cluster at the midpoint detected by the Mpoint 132.

In addition, the Regen 134 is configured to regenerate the remaining data to be transmitted to the next cluster following the start bit. If the received data from the previous cluster needs to be stored for a long period of time, memory is required. However, if the data only needs to be stored for a few clock cycles before transmission, a few registers or latches are sufficient for storing the data. Therefore, high-speed operation is possible to regenerate the data.

Finally, the Trx 120 is configured to combine the start bit generated by the Retime 133 and the transmission data (i.e., remaining data) generated by the Regen 134, and to transmit the combined data to the next cluster through data_tx.

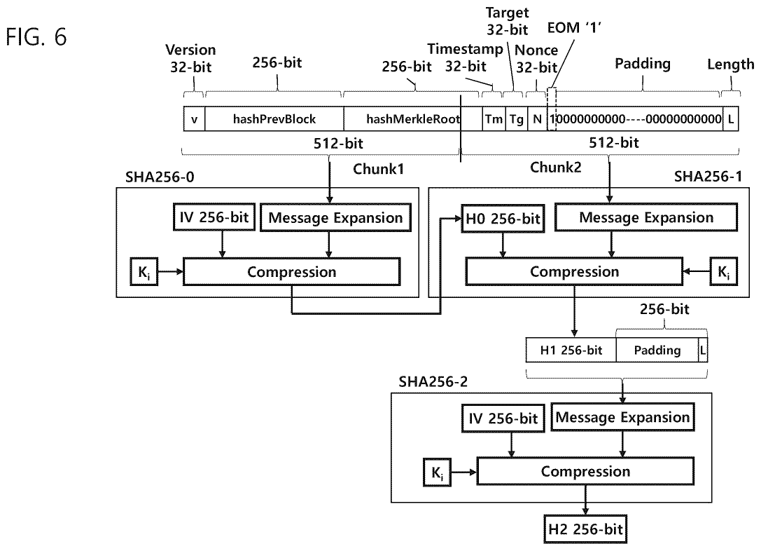

FIG. 6 is a block diagram of performing a hash operation, to which a data transmission and reception device for cluster serialization is applied, according to an embodiment of the present invention.

As shown in FIG. 6, the process of performing a hash operation involves receiving an input message and dividing the input message into 512-bit units. If the total input message length exceeds 512 bits, additional 512-bit input message is formed from the exceeded data. If the exceeded data is not long enough to form a 512-bit of input message, 0′ bits are padded to complete a 512-bit input message.

Specifically, in the case of Bitcoin, the input message consists of a 32-bit version, a 256-bit block derived from the previous hash operation, a 256-bit Merkle root, a 32-bit timestamp, a 32-bit target value, and a 32-bit nonce. To use this input message in a hash operation, a bit of ‘1’ is appended at the end of the input message to indicate the end of the message. In the last 64 bits of the second 512-bit message block, the length of the message (e.g., 0x00000280=640 bits) is added. The bits of ‘1’ are padded between the bit ‘1’ indicating the end of message and the message length.

As illustrated, once two 512-bit input messages are prepared, the first 512-bit input message is processed in SHA256-0 for a message expansion operation, where the 16 32-bit input words are expanded and scheduled into 64 32-bit words.

The expanded message is then compressed together with predefined input constants (Kᵢ) and a 256-bit initialization vector (IV), then the SHA256-0 hash operation results in a 256-bit hash digest (H0).

The resulting 256-bit hash digest (H0) is then applied to the second hash operation, SHA256-1, where the hash digest H0 and input constants Kᵢ together with the message expanded and scheduled from the second 512-bit input message (consisting of 16×32-bit words) into 64 32-bit words are applied to a compression operation of the SHA256-1 hash operation.

The result of the compression operation results in another 256-bit hash value (or hash digest) (H1), which then serves as the input message for the third hash operation, SHA256-2.

Since the hash value H1 becomes the input message of the SHA256-2 hash operation, the bit ‘1’ is appended to the hash value H1, and a 64-bit message length field is appended at the end of the input message. In this case, the message length is 0x100 (=256).

In the third hash operation, SHA256-2, the 256-bit initialization vector (IV), input constants (Kᵢ), and the data expanded the input message into 64×32-bit scheduled message are input into the compression operation to finally produce the final hash output (H2).

If the resulting hash value H2 is less than or equal to the target value, a new block is considered to have been found. Wherein each hash operation (SHA256-0, SHA256-1, SHA256-2) includes operation blocks (expanders and compressors for round function operations) for message expansion operations and compression operations.

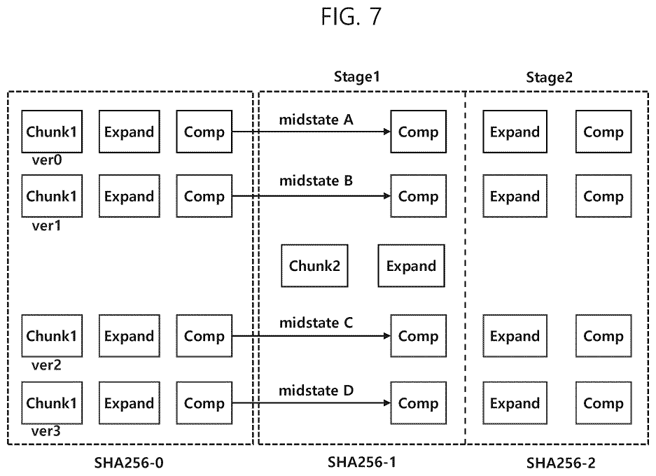

FIG. 7 is a configuration diagram of a cluster for performing hash operation, to which a data transmission and reception device for cluster serialization is applied, according to an embodiment of the present invention.

As shown in FIG. 7, the structure of the cluster according to the present invention is configured to perform expansion (expand) and compression (comp) based on chunk1 and pass the intermediate states (midstates) midstate A, midstate B, midstate C, and midstate D which are resulting from chunk1, to the corresponding compressors (comp) of Stage 1.

For convenience, while SHA256-0 is shown as being performed outside the clusters, SHA256-1 and SHA256-2 are shown as being performed within Stage 1 and Stage 2 of each cluster, in practice, especially the expansion operations for W0, W1, W2, and W3 among input messages and their corresponding round functions with W0, W1, W2, and W3 as input messages among the expansion and compression operations of SHA256-1 may also be executed outside the clusters.

In chunk2, the input messages corresponding to W0 to W3 which include the last 32 bits of the Merkle root, the timestamp, the target value, and the nonce respectively are already known constants, and the nonce is rolled repeatedly from 0 to 32′hFFFFFFFF in each cluster. Therefore, compression operations involving W0˜W3 as input messages can be precomputed outside the clusters.

As such, midstates A, B, C, and D may not only represent the results of SHA256-0, but may also be intermediate states (midstates) generated after the initial 4 rounds of SHA256-1 to which the output of SHA256-0 is applied.

The version of Chunk1 changes more slowly than the nonce of Chunk2. Even when the version of Chunk1 changes, that of Chunk2 remains the same input message. Therefore, for multiple versions of Chunk1 (e.g., ver1, ver2, ver3, ver4), the expander (Expand) of Chunk2 can be shared in Stage 1 to perform the SHA256-1 hash operation. That is, 4 versions can be simultaneously processed. It can be seen as a 4-core cluster structure.

Meanwhile, Stage 2 is configured to perform the expansion (Expand) and compression (Comp) operations using the hash result H1 from Stage 1 and the remaining 256 bits of Chunk2 (which include ‘0’ padding+message length).

Wherein, Stage 1 and Stage 2 can be configured to perform hash operations by rolling the nonce up to 17 million times. For example, if each cluster is configured to perform around 17 million nonce rollings, then a total of 2³² times nonce rollings can be achieved with 249 clusters in a chip.

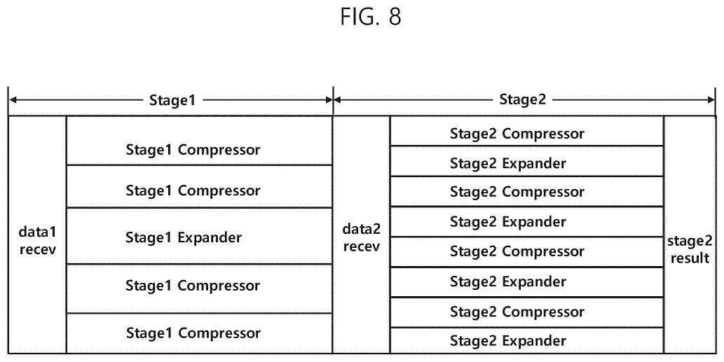

FIG. 8 is a diagram illustrating a usage of received data in a cluster for performing a hash operation, to which a data transmission and reception device for cluster serialization is applied, according to an embodiment of the present invention.

As shown in FIG. 8, in Stage 1, the 4th results from the expander and compressor of SHA256-1 are provided for each version of Chunk1, and one expander is shared for four compressors.

Wherein, data1 is included in data_rx shown in FIGS. 4 and 5 and serves as inputs to Stage 1. data1 represents that the intermediate state (midstate) results after computing the first four rounds of SHA256-1 are received serially. The received data1 is then de-serialized into 32-bit units and the 32-bit data is used in Stage 1.

Since data1 reflects the states after the first four rounds of SHA256-1, the remaining part excluding the first four message blocks among the messages of Chunk2 consists of fixed values including end of message (0x80000000), ‘1’ padded data, and message length (0x00000280).

Therefore, the remaining part does not additionally need to be received.

Additionally, data2 in Stage 2 serves as the input for SHA256-2, so data2 adding both the hash result from Stage 1 and the hash result (H0) from SHA256-0 must be fed into the expander of Stage 2.

Therefore, the hash result H0 from SHA256-0 is received serially through data2, the data2 is de-serialized into 32-bit units and used for input message of Stage 2. It follows the Davies-Meyer construction, where the input of a hash function is added with the hash result (a, b, c, d, e, f, g, h) to produce a message digest as a final hash result.

In Stage 2, after executing 60 rounds of the hash function from Round 1 to Round 60, it is possible to determine in advance whether a valid block has been found by monitoring the value of e for the previous three rounds of h. In SHA256-2, the output hash value is arranged in the order of h, g, f, e, d, c, b, and a, forming a 256-bit sequence. If the value of h in the final hash values does not satisfy the Bitcoin target value difficulty condition of being at least zero, it is determined that no valid hash block has been found, and it is configured to exit without executing Round 61 to 63. If the value of e for the previous three rounds of h is zero, the remaining three rounds(Round 61 to 63) are executed, and if the resulting hash value is less than or equal to the target value, a new valid hash block is considered to have been found.

Wherein, the hash value h was previously g, g was f, and f was originally e, and thus if the value of e in three rounds prior to the final round (Round 63), is not zero, it is determined that a valid hash block has not been found, and the subsequent rounds are not executed but terminated. Thus, it leads to reduced power consumption. For reference, the first round of SHA256-2 is configured to perform the operation by adding the input hash values and the hash results together at the end of Stage 1.

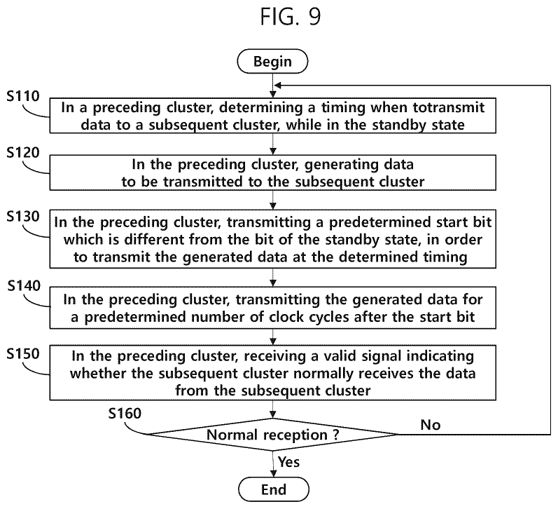

FIG. 9 a flowchart illustrating a data transmission procedure in a data transmission and reception method for cluster serialization according to an embodiment of the present invention.

As shown in FIG. 9, the data transmission and reception procedures according to one embodiment of the invention begin with transiting to a standby state in each data transmission and reception device 100 included in each cluster. The transiting of the standby state can be configured to enter the standby state when each cluster receives a standby signal (e.g., ‘1’) from the previous cluster or autonomously enter the standby state in each cluster.

Subsequently, the Retime 133 is configured to decide a transmission timing when the previous cluster should transmit data to the next cluster in the standby state, S110. Then the Regen 134 is configured to generate a data to be transmitted from the previous cluster to the next cluster S120.

Then, the Trx 120 in the previous cluster is configured to transmit a predefined start bit, which is different from the bit for the standby state, in order that the previous cluster transmits the data generated according to the determined timing, S130. After the procedure of S130, the Trx 120 is configured to transmit the generated data over a predefined number of clock cycles after the start bit, S140. Thus, the start bit and the data are transmitted via the data_tx.

Subsequently, in the Trx 120, a valid signal is received. Wherein the valid signal (valid bit) indicates whether the transmitted start bit and the data were correctly received in the next cluster, S150. Wherein the valid bit also indicates whether the data and start bit were received correctly according to the predefined protocol.

If it is confirmed that the data was correctly received, via the valid bit (or signal), S160, the data transmission and reception device 100 enters the standby state. However, if it is confirmed that the data was not correctly received, via the valid bit, S160, the data transmission and reception device 100 retransmits the previously transmitted data. Wherein, the retransmitting of the previously transmitted data includes repeating in sequence, the transiting of the standby state by the data transmission and reception device, the determining of transmission timing by the Retime, the generating of transmission data by the Regen, the transmitting of the start bit by the Trx, the transmitting of the data, and the receiving of the valid signal (bit).

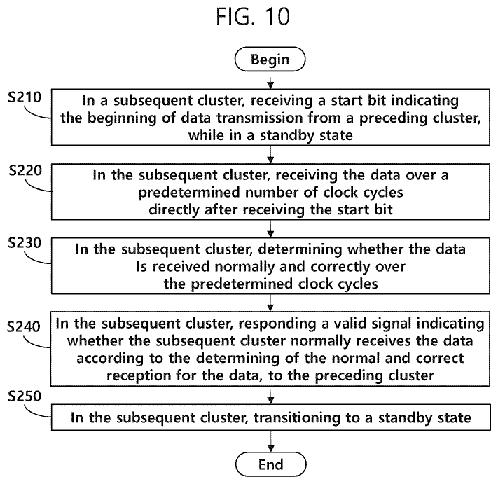

FIG. 10 is a flowchart illustrating a data reception procedure in a data transmission and reception method for cluster serialization according to an embodiment of the present invention.

As shown in FIG. 10, the data transmission and reception method for cluster serialization according to one embodiment of the present invention, comprises receiving a start bit through the Rtx 110. Wherein the start bit indicates that data transmission has started from the previous cluster, while the Rtx 110 is in a standby state S210.

Subsequently, the Rtx 110 receives a data over a predetermined number of clock cycles after receiving the start bit, S220.

Then, the Rtx 110 determines whether the data has been correctly received over the given number of cycles S230.

The Rtx 110 replies a valid signal back to the previous cluster. Wherein, the valid signal indicates whether the data was correctly received according to the determination result, 240.

Finally, the data transmission and reception device 100 transits a standby state by returning to the standby state S250.

Each cluster can be configured to transmit data to the next cluster immediately after completing the above data reception procedure from the previous cluster (Refer to FIG. 4). Hereinafter, the process of transmitting data in conjunction with the reception process will be described.

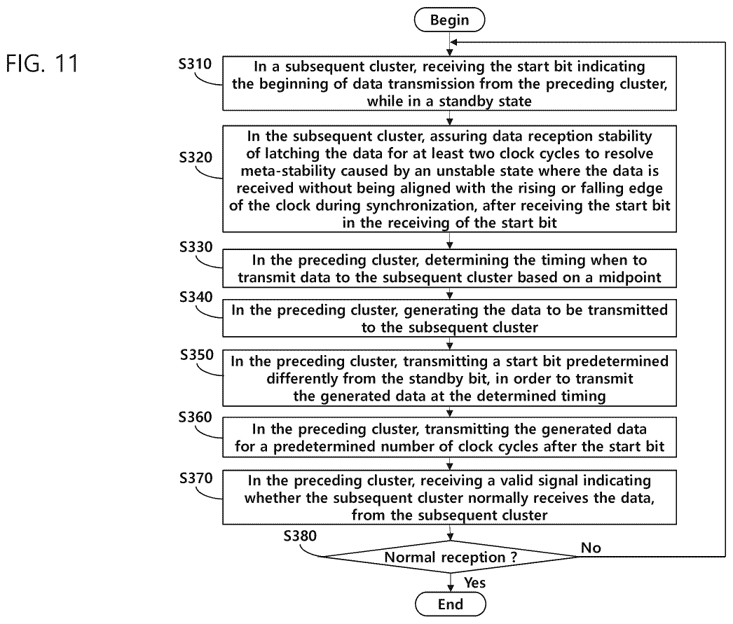

FIG. 11 is a flowchart illustrating a procedure of data reception and a corresponding data transmission interworked with the data reception in a data transmission and reception method for cluster serialization according to an embodiment of the present invention.

As shown in FIG. 11, a data transmission and reception method for cluster serialization according to an embodiment of the present invention, is configured to receive a start bit by the Rtx 110 in a subsequent cluster, indicating that data transmission from the previous (preceding) cluster has started while in a standby state, S310.

Subsequently, the MetaS 131 of a subsequent cluster assures data reception stability, in which data is latched for at least 2 clock cycles to resolve any metastability occurring unstable state caused by receiving data without aligning with the rising or falling edge of the clock during synchronization process, S320.

Then, the Retime 133 of a preceding cluster determines timing when to transmit data to the subsequent cluster based on a midpoint, S330.

Then the Regen 134 of the preceding cluster generates data to be transmitted to the subsequent cluster, S340.

Subsequently, the Trx 120 of the preceding cluster transmits a start bit predetermined differently from the standby state bit at the determined timing for transmitting the generated data, S350.

Then, the Trx 120 of the preceding cluster transmits the generated data over a predetermined number of clock cycles after the start bit, S360.

Finally, the Trx 120 of the preceding cluster receives a valid signal (data) from the subsequent cluster indicating whether the data was received correctly, S370. If the received valid signal confirms correct (normal) reception, S380, the data transmission and reception device 100 transits back to the standby state.

Meanwhile, if the received valid signal indicates that the data was not correctly (normally) received, S380, a data retransmission is performed. The data retransmission repeats from S310 to S370. In other words, the data retransmission sequentially re-executes the receiving of the start bit, S310, the assuring of data reception stability, S320, the determining of the transmission timing, S330, the generating of the transmission data, S340, the transmitting of the start bit, S350, the transmitting of the henerated data, S360, and the receiving of the valid signal, S370.

As described above, it is effective of the present invention to improve performance by reducing latency through high-speed communication between clusters using local clocks and reduce power consumption and chip area in a semiconductor chip composed of multiple clusters, by simplifying the communication protocol through reducing handshaking conditions required for data communication, and by configuring to repeatedly carry out a command relay process by using local clocks used within each cluster, wherein the process is that each cluster is serially connected so that if a preceding cluster finishes to receive data or commands for its operation then it sends data or commands to a subsequent cluster to perform its subsequent operation, by using local clocks used within each cluster.

At least one of the components, elements, modules or units (collectively “components” in this paragraph) represented by a block or an equivalent indication in the drawings including FIGS. 5A, 5B and 6 may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium that is readable by at least one processor. For example, the at least one processor may invoke at least one of the one or more instructions stored in the storage medium, and execute it, with or without using one or more other components under the control of the at least one processor. This allows the at least one processor to perform at least one function or operation described above as being performed by each of the components according to the at least one instruction invoked. Here, the at least one processor may include a central processing unit (CPU), a graphic processing unit (GPU), another type of microprocessor, not being limited thereto.

While the present disclosure has been described with reference to embodiments illustrated in figures, these embodiments are only examples. It will be understood by those skilled in the art that various modifications and equivalent embodiments are possible therefrom. Therefore, the technical scope of the present invention should be determined by the claims below.

What is claimed is:

1. A method of transmitting and receiving data for cluster serialization, comprising:
in a preceding cluster, determining a timing for transmitting data to a subsequent cluster, while the preceding cluster is in a standby state;
in the preceding cluster, generating the data to be transmitted to the subsequent cluster;
in the preceding cluster, transmitting a start bit to initiate transmission of the generated data at the determined timing, wherein the start bit is predetermined differently from the standby bit; and
in the preceding cluster, transmitting the generated data for a predetermined number of clock cycles immediately after the start bit.

2. The method of claim 1, wherein the method further comprising:
in the preceding cluster, receiving a valid signal from the subsequent cluster, wherein the valid signal indicates that the subsequent cluster normally receives the data;
in the preceding cluster, retransmitting the previously transmitted data, if the valid signal is not normally received from the subsequent cluster; and
in the preceding cluster, transitioning to a standby state, if the valid signal is normally received from the subsequent cluster over a predetermined number of clock cycles,
wherein the retransmitting of the data includes re-executing transitioning to the standby state, the determining of the transmission timing for the previously transmitted data, the generating of the previously transmitted data, the transmitting of the start bit, and the transmitting of the previously transmitted data.

3. The method of claim 1, wherein the method further comprising:
in the subsequent cluster, receiving the start bit indicating the beginning of data transmission from the preceding cluster, while the subsequent cluster is in a standby state;
in the subsequent cluster, receiving the data over a predetermined number of clock cycles directly after receiving the start bit;
in the subsequent cluster, determining whether the data is received normally and correctly over the predetermined clock cycles; and
in the subsequent cluster, responding the valid signal to the preceding cluster, wherein the valid signal indicates whether the subsequent cluster normally receives the data according to the determining of the normal and correct reception for the data.

4. The method of claim 3, wherein the method further comprising:
in the subsequent cluster, securing data reception stability of latching the data for at least two clock cycles to resolve meta-stability caused by an unstable state where the data is received without being aligned with the rising or falling edge of the clock during synchronization, after receiving the start bit in the receiving of the start bit.

5. The method of claim 4, wherein the determining of the transmission timing is further configured to determine the timing when each of the plurality of determines the timing for regenerating and transmitting data based on a midpoint, wherein the midpoint is detected at a predetermined number of clock cycles, after the subsequent cluster receives the start bit or the data from the preceding cluster, latches the data for at least two clock cycles to secure the data reception stability.

6. The method of claim 1, wherein the method further comprising:
in a cluster top, transmitting data to a plurality of clusters, wherein the cluster top is configured to transmit the data to a most preceding cluster at the first time.

7. A device of transmitting and receiving data for cluster serialization, comprising:
a transmission timing determiner configured to determine a timing for transmitting data to a subsequent cluster, while the preceding cluster is in a standby state;
a data regenerator configured to generate the data to be transmitted in the previous cluster to the subsequent cluster; and
a first transceiver configured to transmit a start bit which is predetermined differently from the standby bit, in order to transmit the generated data according to the determined timing in the preceding cluster, and transmit the generated data over a predetermined number of clock cycles directly after the start bit.

8. The device of claim 7, wherein the device is further configured to:
in the preceding cluster, receive a valid signal from the subsequent cluster, wherein the valid signal indicates that the subsequent cluster normally receives the data;
in the preceding cluster, retransmit the previously transmitted data, if the valid signal is not normally received from the subsequent cluster; and
in the preceding cluster, transit to a standby state, if the valid signal is normally received from the subsequent cluster over a predetermined number of clock cycles, as a result of the reception of the valid signal,
wherein the retransmitting of the data includes re-executing transitioning to the standby state, the determining of the transmission timing for the previously transmitted data, the generating of the previously transmitted data, the transmitting of the start bit, and the transmitting of the previously transmitted data.

9. The device of claim 7, wherein the device further comprises: a second transceiver configured to:
i) in the subsequent cluster, receive the start bit indicating the beginning of data transmission from the preceding cluster, while the subsequent cluster is in a standby state;
ii) in the subsequent cluster, receive the data over a predetermined number of clock cycles directly after receiving the start bit; and
iii) in the subsequent cluster, confirm whether the data is received normally and correctly over the predetermined clock cycles, and transmit the valid signal to the preceding cluster, wherein the valid signal indicates whether the subsequent cluster normally receives the data according to the confirming of the normal and correct reception for the data.

10. The device of claim 7, wherein the device further comprises:
a meta stabilizer, configured to assure data reception stability of latching the data for at least two clock cycles to resolve meta-stability caused by an unstable state where the data is received without being aligned with the rising or falling edge of the clock during synchronization, after receiving the start bit in the receiving of the start bit in the subsequent cluster.

11. The device of claim 7, wherein the transmission timing determiner is further configured to determine the timing when each of the plurality of determines the timing for regenerating and transmitting data based on a midpoint, wherein the midpoint is detected at a predetermined number of clock cycles, after the subsequent cluster receives the start bit or the data from the preceding cluster, latches the data for at least two clock cycles to secure the data reception stability.

12. The device of claim 7, wherein the device is further configured to transmit data to a plurality of clusters in a cluster top, wherein the cluster top is configured to transmit the data to a most preceding cluster at the first time.
